(19) United States
(12) Patent Application Publication
(10) Pub. No.: US 2025/0155715 A1
(43) Pub. Date: May 15, 2025

(54) LIGHT GUIDE PLATE AND IMAGE DISPLAY DEVICE

(71) Applicant: SONY GROUP CORPORATION, TOKYO (JP)

(72) Inventor: KAZUE SHIMIZU, TOKYO (JP)

(21) Appl. No.: 18/840,023

(22) PCT Filed: Jan. 16, 2023
(86) PCT No.: PCT/JP2023/001026

§ 371 Date: Aug. 20, 2024

(30) Foreign Application Priority Data
Feb. 28, 2022 (JP) 2022-029667

(51) Int. Cl. G02B 27/01; G02B 6/34

(52) U.S. Cl. CPC G02B 27/0172; G02B 6/34

(57) ABSTRACT

To improve image quality by suppressing a loss caused by Fresnel reflection. Provided is a light guide plate including at least an incidence diffraction grating that diffracts incident light into the light guide plate, a substrate that internally and totally reflects the light diffracted into the light guide plate by the incidence diffraction grating and guides the light, and a function part that transmits or reflects the incident light or performs both of the transmission and the reflection, wherein when the substrate has a refractive index of n_{b},

a transmittance T0 of zeroth-order transmitted light of the function part substantially at the center of the field angle area for guiding light satisfies formula below:

$$T 0 > 1 - {( {n}_{b} - 1 )}^{2} / {( {n}_{b} + 1 )}^{2}$$

### TECHNICAL FIELD

The present technique relates to a light guide plate and an image display device.

### BACKGROUND ART

Conventionally in order to achieve extended reality (XR) including augmented reality (AR), virtual reality (VR), and mixed reality (MR), light guide plates that project image light into the pupils of an observer have been developed.

Light guide plates have been developed with wider field angles in recent years. It is known that a field angle increases with the refractive index of a material of a light guide plate. Thus, materials having high refractive indexes are mainly used.

However, a higher refractive index may cause Fresnel reflection on the boundary surface of a light guide plate, disadvantageously leading to image degradation. For example, PTL 1 to 3 disclose techniques relating to light guide plates that suppress image degradation.

### CITATION LIST

### Patent Literature

### [PTL 1]

U.S. Patent Application Publication No. 2019/0227321

### [PTL 2]

U.S. Patent Application Publication No. 2008/0193080

### [PTL 3]

U.S. Patent Application Publication No. 2021/0096379

### SUMMARY

### Technical Problem

However, the techniques disclosed in PTL 1 to 3 leave room for improvement in the suppression of a loss caused by Fresnel reflection.

Hence, the primary object of the present technique is to provide a light guide plate and an image display device that improve image quality by suppressing a loss caused by Fresnel reflection.

### Solution to Problem

The present technique provides a light guide plate including at least an incidence diffraction grating that diffracts incident light into the light guide plate, a substrate that internally and totally reflects the light diffracted into the light guide plate by the incidence diffraction grating and guides the light, and a function part that transmits or reflects the incident light or performs both of the transmission and the reflection, wherein when the substrate has a refractive index of n_{b}, a transmittance T0 of zeroth-order transmitted light of the function part substantially at the center of the field angle area for guiding light satisfies formula (2) below:

$$T 0 > 1 - {( {n}_{b} - 1 )}^{2} / {( {n}_{b} + 1 )}^{2} \qquad ( 2 )$$

When a ratio S1 is defined between a cross-sectional area of a pencil of light in parallel with the incidence diffraction grating and a cross-sectional area of the pencil of light impinging on the function part, the pencil of light being diffracted into the light guide plate by the incidence diffraction grating, a reflectance R0 of zeroth-order reflected light of the function part may satisfy formula (3) below:

$$T 0 \times ( 1 - S 1 ) + T 0 \times S 1 \times R 0 > 1 - ( {n}_{b} - {1}^{2} / {( {n}_{b} + 1 )}^{2} \qquad ( 3 )$$

The light guide plate may further include one or both of an emission diffraction grating that diffracts the light guided by the substrate and emits the light into the pupils of an observer and an expansion diffraction grating that expands the light by diffracting the light in a direction orthogonal to the axis of light in front view, the light being incident from the incidence diffraction grating into the light guide plate.

The sum of a grating vector and a basic grating vector may be 0, the grating vector being provided for the incidence diffraction grating, the basic grating vector being provided for the emission diffraction grating or the expansion diffraction grating or both of the diffraction gratings.

The emission diffraction grating may include a grating vector having the function of returning light and connecting the vertexes of a polygon including grating vectors that sum up to 0.

The magnitude of the grating vector provided for the function part may be equal to substantially an integer multiple of the magnitude of the grating vector provided for the incidence diffraction grating, the integer multiple being set at 2 or more, and the direction of the grating vector provided for the function part may be substantially parallel to the grating vector provided for the incidence diffraction grating.

The magnitude of the grating vector provided for the function part may be equal to substantially an integer multiple of the magnitude of the grating vector provided for the emission diffraction grating, the integer multiple being set at 2 or more, and the direction of the grating vector provided for the function part may be substantially parallel to the grating vector provided for the emission diffraction grating.

The magnitude of the grating vector provided for the function part may be substantially equal to the magnitude of the grating vector having the function of returning the light, and the direction of the grating vector provided for the function part may be substantially parallel to the grating vector having the function of returning the light.

In wave number space coordinates, when the wave vector of light incident into the light guide plate is k_{λ}, the grating vector provided for the incidence diffraction grating is k_{IN}, the grating vector provided for any diffraction gratings other than the incidence diffraction grating and the function part is k_{g}, the grating vector provided for the function part is k_{F}, the sum of the grating vectors determined by a light beam path P (P includes an empty set) except for the grating vectors provided for the incidence diffraction grating and the function part is Σ_{g∈P}k_{g}, a wave vector connecting the origin point and the boundary between the light guide region and the evanescent region of the light guide plate is k_{W}, formula (1) presented below may be satisfied for all optical path.

$$[ Math . 1 ]$$

$$\vert \vec{{k}_{λ}} + \vec{{k}_{IN}} + {\sum }_{g ∈ P} \vec{kg} + \vec{{k}_{F}} \vert \geq \vert \vec{{k}_{W}} \vert \qquad ( 1 )$$

Among the faces of the function part, the entry face of the light or the emission surface of the light or both of the faces may be substantially flat faces with diffraction gratings at a height of 20 nm or less, the refractive index of the function part may be lower than the refractive index of the substrate by 0.1 or more, and the thickness of a residual film formed between the diffraction grating provided for the function part and the substrate may be 20 nm or more.

The residual film thickness may be 40 nm or more.

The refractive index of the function part may decrease as a distance from the substrate increases in side view.

The refractive index of the function part may be higher than the refractive index of the substrate by 0.1 or more, and the thickness of a residual film formed between the diffraction grating provided for the function part and the substrate may be smaller than 20 nm.

The grating vector provided for the function part may have diffraction efficiency of 5% or less to the extent that the following formula (4) is satisfied:

$$[ Math . 2 ]$$

$$\vert \vec{{k}_{λ}} + \vec{{k}_{IN}} + {\sum }_{g ∈ P} \vec{kg} + \vec{{k}_{F}} \vert < \vert \vec{{k}_{W}} \vert \qquad ( 4 )$$

In side view, the cross-sectional shape of the diffraction grating provided for the function part may be asymmetrical with respect to a direction orthogonal to a direction along which the light is incident at an incident angle of 0°.
The function part may be provided on an optical path where the light to be incident into the incidence diffraction grating travels straight ahead.
The function part may be provided on an optical path where the light to be emitted from the emission diffraction grating travels straight ahead.
The function part may be provided on the optical path where the light to be incident into the incidence diffraction grating travels straight ahead and the optical path where the light to be emitted from the emission diffraction grating travels straight ahead.

The present technique further provides an image display device including the light guide plate and an image forming unit that emits image light onto the light guide plate.

The present technique can provide a light guide plate and an image display device that can improve image quality by suppressing a loss caused by Fresnel reflection, without significantly increasing the number of manufacturing steps. The effects described here are not necessarily limited and may be any of the effects described in the present disclosure.

### BRIEF DESCRIPTION OF DRAWINGS

FIG. 1 is a schematic front view illustrating a configuration example of a light guide plate 1 according to an embodiment of the present technique.

FIG. 2 is a schematic side view illustrating the configuration example of the light guide plate 1 according to the embodiment of the present technique.

FIG. 3 shows wave number space coordinates indicating a design example of grating vectors according to the embodiment of the present technique.

FIG. 4 shows wave number space coordinates indicating a design example of grating vectors according to the embodiment of the present technique.

FIG. 5 shows wave number space coordinates indicating a design example of grating vectors according to the embodiment of the present technique.

FIG. 6 shows wave number space coordinates indicating a design example of grating vectors according to the embodiment of the present technique.

FIG. 7 shows wave number space coordinates indicating a design example of grating vectors according to the embodiment of the present technique.

FIG. 8 is an explanatory drawing illustrating a ratio S1 according to the embodiment of the present technique.

FIG. 9A is a schematic side view illustrating a configuration example of the light guide plate 1 according to the embodiment of the present technique. FIG. 9B is a graph indicating a design example of a transmittance of a function part 6 according to the embodiment of the present technique. FIG. 9C is a graph indicating a design example of a reflectance of the function part 6 according to the embodiment of the present technique.

FIG. 10 is a graph showing an example of a transmittance on the surface of a light guide plate according to a comparative example of the embodiment of the present technique.

FIG. 11 shows wave number space coordinates indicating a design example of grating vectors according to an embodiment of the present technique.

FIG. 12 shows wave number space coordinates indicating a design example of grating vectors according to the embodiment of the present technique.

FIG. 13 shows wave number space coordinates indicating a design example of grating vectors according to an embodiment of the present technique.

FIG. 14 is a schematic side view illustrating a configuration example of the light guide plate 1 according to an embodiment of the present technique.

FIG. 15 is a schematic cross-sectional view illustrating a configuration example of diffraction gratings provided for the function part 6 according to the embodiment of the present technique.

FIG. 16 is a schematic side view illustrating a configuration example of the light guide plate 1 according to an embodiment of the present technique.

FIG. 17 is a graph showing simulation results of the function part 6 according to the embodiment of the present technique.

FIG. 18 is a schematic side view illustrating a configuration example of the light guide plate 1 according to an embodiment of the present technique.

FIG. 19A is a graph indicating a design example of a transmittance of the function part 6 according to the embodiment of the present technique. FIG. 19B is a graph indicating a design example of a reflectance of the function part 6 according to the embodiment of the present technique.

FIG. 20 is a schematic front view illustrating configuration examples of the light guide plate 1 according to an embodiment of the present technique.

FIG. 21 is a schematic side cross-sectional view illustrating a configuration example of a light guide plate 1 according to an embodiment of the present technique.

FIG. 22 is a schematic side cross-sectional view illustrating a configuration example of a light guide plate 1 according to an embodiment of the present technique.

### DESCRIPTION OF EMBODIMENTS

Hereinafter, preferable embodiments for implementing the present technique will be described with reference to the drawings. The embodiments described below illustrate examples of representative embodiments according to the present technique and do not limit the scope of the present technique. Moreover, according to the present technique, some of the following examples and modifications thereof can be combined.

In the descriptions of the embodiments, the configurations may be described using terms with “substantially”, for example, nearly parallel or nearly orthogonal. For example, “substantially parallel” means a parallel state in essence, that is, a state of shift from perfect parallelism by, for example, about several percents, as well as perfect parallelism. The same applies to other terms with “substantially”. Furthermore, the drawings are schematic and are not necessarily exact illustrations.

In the drawings, unless otherwise specified, “up” means the upper direction or the upper side in the drawing, “down” means the lower direction or the lower side in the drawing, “left” means the left direction or the left side in the drawing, and “right” means the right direction or the right side in the drawing. Also, the same reference numerals are given to the same or equivalent elements or members in the drawings, and redundant descriptions thereof are omitted.

Descriptions will be given in the following order:
1. First Embodiment (Example 1 of Light Guide Plate)
(1) Conventional Art
(2) Configuration of Present Embodiment
(3) Effects of Function Part
(4) Transmittance and Reflectance of Function Part
2. Second Embodiment (Example 2 of Light Guide Plate)
3. Third Embodiment (Example 3 of Light Guide Plate)
4. Fourth Embodiment (Example 4 of Light Guide Plate)
5. Fifth Embodiment (Example 5 of Light Guide Plate)
6. Sixth Embodiment (Example 6 of Light Guide Plate)
7. Seventh Embodiment (Example 7 of Light Guide Plate)
8. Eighth Embodiment (Example 8 of Light Guide Plate)
9. Ninth Embodiment (Example 9 of Light Guide Plate)
10. Tenth embodiment (Example of Image Display Device)

### 1. First Embodiment (Example 1 of Light Guide Plate)

### (1) Conventional Art

Conventionally in order to suppress a loss caused by Fresnel reflection, antireflective films called AR coatings (Anti-Reflection Coating) are generally used.

For example, in PTL 1 (U.S. Patent Application Publication No. 2019/0227321 (Specification)), a diffraction grating for emitting light is configured with a tilt by using a volume phase holographic grating (VPHG), thereby suppressing a rainbow effect caused by light incident from the outside of a light guide plate. However, on an emission surface where the diffraction grating is not provided, Fresnel reflection may generate unnecessarily reflected light, leaving a rainbow. Thus, PTL 1 proposes suppression of Fresnel reflection by forming an antireflective film on a surface of the light guide plate.

For an ordinary antireflective film in manufacturing of the light guide plate, however, the step of forming the antireflective film is necessary disadvantageously leading to a complicated manufacturing process. Although an antireflective film having a moth-eye structure is also proposed, the process of producing an original plate is necessary in addition to the light guide plate, leading to an increase in cost.

PTL 2 (U.S. Patent Application Publication No. 2008/0193080 (Specification)) proposes that a loss caused by Fresnel reflection on a surface is suppressed by providing a sub-pitch structure smaller than primary diffraction on the surface of an optical fiber.

However, an optical fiber transmits far-red light having a wavelength of 1 μm or more, requiring a large pitch. Thus, it is difficult to apply the structure as it is to the present technique. Moreover, the system proposed in PTL 2 is designed for optical fibers and is characterized by a refractive index changing with varying pitches instead of uniform pitches. Furthermore, only grating conditions are set without primary diffraction, the application of this technique to the present technique may generate unnecessarily diffracted light with respect to returned light in a light guide plate. Moreover, the thickness of the light guide plate relative to an area for collecting light into the light guide plate is quite smaller than the thickness of the optical fiber. Thus, even if the transmittance of light incident into the light guide plate is increased, unfortunately the light incident into the light guide plate may impinge on the small pitch structure again, causing double diffraction.

PTL 3 (U.S. Patent Application Publication No. 2021/0096379 (Specification)) proposes that a loss caused by Fresnel reflection is suppressed by providing a small pitch structure in a direction orthogonal to a gap of the pitch structure of a diffraction grating.

Unfortunately a small pitch is additionally provided on the diffraction grating, leading to a complicated mold-making process. In addition, the diffraction grating can be designed to suppress a loss caused by Fresnel reflection. Thus, in the present technique, a loss caused by Fresnel reflection on the diffraction grating is negligible. Fresnel reflection causes a problem if light is incident or emitted from a surface where no diffraction grating is provided. The present technique can solve this problem. The present technique can also suppress double diffraction of light incident into a light guide plate.

Through diligent study the inventor successfully developed the configuration of a novel light guide plate that suppresses a loss caused by Fresnel reflection, by using a pitch, an aspect ratio, and materials in an ordinary range of use in manufacturing of light guide plates. The present technique can reduce manufacturing cost, suppress image quality deterioration caused by the occurrence of ghosts, and improve light use efficiency. This leads to lower power consumption and higher luminance as a module.

### (2) Configuration of Present Embodiment

The present technique provides a light guide plate including at least an incidence diffraction grating that diffracts incident light into the light guide plate, a substrate that internally and totally reflects the light diffracted into the light guide plate by the incidence diffraction grating and guides the light, and a function part that transmits or reflects the incident light or performs both of the transmission and the reflection, wherein the magnitude of a grating vector provided for the function part is equal to substantially an integer multiple of the magnitude of the grating vector provided for the incidence diffraction grating, the integer multiple being set at 2 or more, and the direction of the grating vector provided for the function part is substantially identical to the direction of the grating vector provided for the incidence diffraction grating.

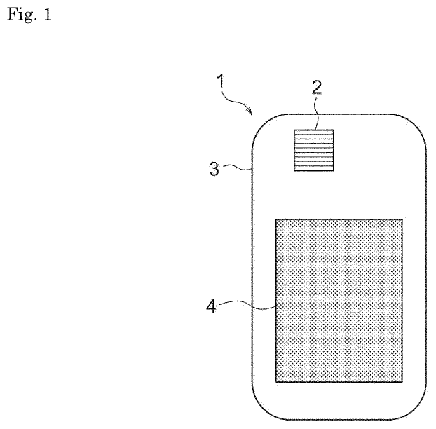

Referring to FIG. 1, a configuration example of a light guide plate according to an embodiment of the present technique will be described below. FIG. 1 is a schematic front view illustrating a configuration example of a light guide plate 1 according to the embodiment of the present technique.

As illustrated in FIG. 1, the light guide plate 1 includes at least an incidence diffraction grating 2, a substrate 3, and a function part (not illustrated). The light guide plate 1 further includes an emission diffraction grating 4.

For example, a surface relief grating (SRG) or a volume phase holographic grating (VPHG) can be used as the incidence diffraction grating 2, the emission diffraction grating 4, and the function part. If a volume phase holographic grating is used, a plurality of diffraction gratings may be formed on the same surface or a plurality of diffraction gratings may be configured as a laminate. Hereinafter, a surface relief grating will be described as an example of the incidence diffraction grating 2, the emission diffraction grating 4, and a function part 6.

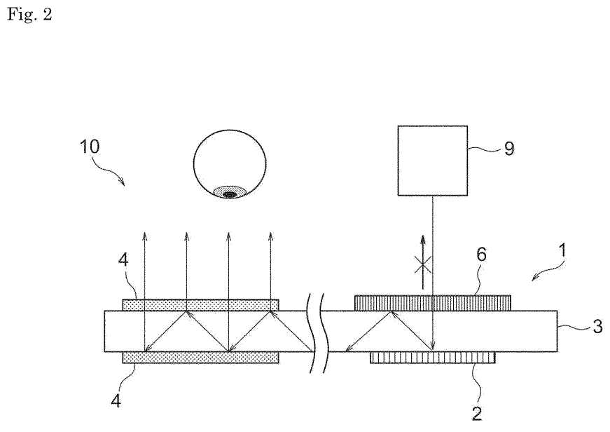

Referring to FIG. 2, a configuration example of the light guide plate according to the embodiment of the present technique will be described below. FIG. 2 is a schematic side view illustrating the configuration example of the light guide plate 1 according to the embodiment of the present technique.

As illustrated in FIG. 2, the light guide plate 1 includes at least an incidence diffraction grating 2, the substrate 3, and the function part 6. The light guide plate 1 further includes the emission diffraction grating 4.

The incidence diffraction grating 2 diffracts substantially parallel rays with respect to light incident at each field angle from an image forming unit 9 for forming image light, into the light guide plate. The substrate 3 internally and totally reflects light diffracted into the light guide plate 1 by the incidence diffraction grating 2 and guides the light. The emission diffraction grating 4 diffracts the guided by the substrate 3 and emits the light into the eyes of an observer. Thus, light at each image height from the image forming unit is emitted into the eyes of the observer. Consequently the observer can visually identify, as a virtual image, an image generated by the image forming unit.

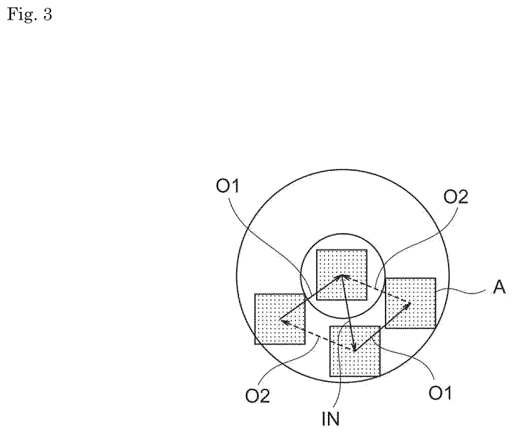

Referring to FIG. 3, a design example of grating vectors provided for the incidence diffraction grating 2 and the emission diffraction grating 4 will be described below. FIG. 3 shows wave number space coordinates indicating the design example of the grating vectors according to the embodiment of the present technique. As shown in FIG. 3, grating vectors IN, O1, and O2 and field angle areas A are indicated.

The grating vector IN indicates a grating vector provided for the incidence diffraction grating 2 for collecting incident light into the light guide plate 1. The grating vectors O1 and O2 indicate basic grating vectors provided for the emission diffraction grating 4 for externally (in plan view, a direction orthogonal to the axis of light incident from the incidence diffraction grating into the light guide plate) expanding light collected into the light guide plate 1 and projecting the light into the pupils of an observer.

In this design example, the grating vectors IN, O1, and O2 constitute a substantially isosceles triangle. The sum of the grating vector IN provided for the incidence diffraction grating 2, the basic grating vector O1 provided for the emission diffraction grating 4, and the basic grating vector O2 is 0. This can suppress a deterioration of image quality. The image quality deteriorates as a difference increases. The basic grating vectors O1 and O2 are present on the front and back sides of the substrate 3.

### (3) Effects of Function Part

The function part 6 transmits or reflects light incident into the light guide plate 1 or performs both of the transmission and the reflection. The reflection includes regular reflection and reflection diffraction. The function part 6 transmits light incident into the light guide plate 1, thereby suppressing a loss caused by Fresnel reflection. The magnitude of the grating vector provided for the function part 6 is preferably equal to substantially an integer multiple of the magnitude of the grating vector provided for the incidence diffraction grating 2, the integer multiple being set at 2 or more. Thus, the function part 6 can suppress ghosts and a reduction in resolution.

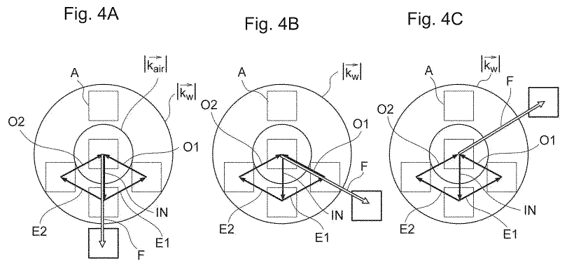

Referring to FIG. 4, a design example of the diffraction gratings provided for the function part 6 will be described below. FIG. 4 shows wave number space coordinates indicating the design example of the grating vectors according to the embodiment of the present technique. As shown in FIG. 4, grating vectors IN, E1, E2, O1, O2, and F and field angle areas Aare indicated.

The grating vector IN indicates a grating vector provided for the incidence diffraction grating 2. Among the grating vectors provided for the emission diffraction grating 4, the grating vectors E1 and E2 indicate grating vectors for externally (in front view, a direction orthogonal to the axis of light incident from the incidence diffraction grating into the light guide plate) expanding light in the front view of the light guide plate 1. The grating vectors O1 and O2 indicate basic grating vectors that emit light into the pupils of an observer, among the grating vectors provided for the emission diffraction grating 4. The grating vector F is a grating vector provided for the function part 6. The grating vectors E1 and E2 and the basic grating vectors O1 and O2 are present on the front and back sides of the substrate 3.

The range from kₐᵢᵣ to k_{W} is a light guide region of the light guide plate 1. In the light guide region, light can be guided. A wave vector connecting an origin point and the boundary between the light guide region and the evanescent region of the light guide plate 1 is denoted as k_{W}.

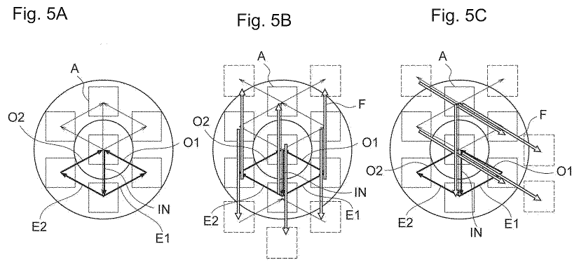

When the terminal point of the grating vector is present in the evanescent region, ghosts and a reduction in resolution or the like can be suppressed. This will be described with reference to FIG. 5. FIG. 5 shows wave number space coordinates indicating a design example of the grating vectors according to the embodiment of the present technique. As shown in FIG. 5, grating vectors IN, E1, E2, O1, O2, and F and field angle areas A are indicated.

The grating vector IN indicates a grating vector provided for the incidence diffraction grating 2. Among the grating vectors provided for the emission diffraction grating 4, the grating vectors E1 and E2 indicate grating vectors for externally (in front view, a direction orthogonal to the axis of light incident from the incidence diffraction grating into the light guide plate) expanding light in the front view of the light guide plate 1. The grating vectors O1 and O2 indicate basic grating vectors that emit light into the pupils of an observer, among the grating vectors provided for the emission diffraction grating 4. The grating vector F is a grating vector provided for the function part 6. The grating vectors E1 and E2 and the basic grating vectors O1 and O2 are present on the front and back sides of the substrate 3.

As illustrated in FIG. 5A, the field angle areas A that can be present in the light guide plate 1 are indicated at the grating vectors IN, E1, E2, O1, and O2.

As shown in FIG. 5B, when the magnitude of the grating vector F provided for the function part 6 is equal to substantially an integer multiple of the magnitude of the grating vector IN, the integer multiple being set at 2 or more, even if double diffraction is performed in the grating vector F, a light beam angle is always formed in the light guide plate 1. Since a displacement of angle can be reduced, image quality deterioration such as ghosts can be suppressed.

As shown in FIG. 5C, when the magnitude of the grating vector F provided for the function part 6 is equal to substantially an integer multiple of the magnitudes of the grating vectors E1 and E2, the integer multiple being set at 2 or more, even if double diffraction is performed in the grating vector F, a light beam angle is always formed in the light guide plate 1. Since a displacement of angle can be reduced, image quality deterioration such as ghosts can be suppressed.

Thus, as shown in FIG. 4A, the magnitude of the grating vector F provided for the function part 6 is preferably equal to substantially an integer multiple of the magnitude of the grating vector IN provided for the incidence diffraction grating 2, the integer multiple being set at 2 or more. In this design example, the magnitude of the grating vector F is equal to substantially an integer multiple of the magnitude of the grating vector IN, the integer multiple being set at 2 or more. The integer multiple may be substantially 3 or more.

The direction of the grating vector F is substantially identical to the direction of the grating vector IN. The directions may be substantially opposite to each other.

For example, as shown in FIG. 4B, the magnitude of the grating vector F provided for the function part 6 may be equal to substantially an integer multiple of the magnitude of the grating vector O1 that emits light into pupils among the grating vectors provided for the emission diffraction grating 4, the integer multiple being set at 2 or more.

The direction of the grating vector F is substantially identical to the direction of the grating vector O1. The directions may be substantially opposite to each other.

Alternatively as shown in FIG. 4C, the magnitude of the grating vector F provided for the function part 6 may be equal to substantially an integer multiple of the magnitude of the grating vector E1 for externally (in front view, a direction orthogonal to the axis of light incident from the incidence diffraction grating into the light guide plate) expanding light in the front view of the light guide plate 1 among the grating vectors provided for the emission diffraction grating 4, the integer multiple being set at 2 or more.

The direction of the grating vector F is substantially identical to the direction of the grating vector E1. The directions may be substantially opposite to each other.

In order to suppress a loss caused by Fresnel reflection, the terminal point of a vector may be present in the evanescent region, the vector serving as the sum of the wave vector of light incident into the light guide plate 1, the grating vector provided for the incidence diffraction grating 2, the grating vector provided for the emission diffraction grating 4, and the grating vector provided for the function part 6. In other words, in wave number space coordinates, formula (1) presented below is preferably satisfied, where k_{λ} is the wave vector of light incident into the light guide plate 1, k_{IN} is the grating vector provided for the incidence diffraction grating 2, k_{g} is the grating vector provided for the emission diffraction grating 4, k_{F} is the grating vector provided for the function part 6, Σ_{g∈P}k_{g} is the sum of the grating vectors determined by a light beam path P (P includes an empty set) except for the grating vectors provided for the incidence diffraction grating 2 and the function part 6, k_{W} is a vector connecting the origin point and the boundary between the light guide region and the evanescent region of the light guide plate.

$$[ Math . 1 ]$$

$$\vert \vec{{k}_{λ}} + \vec{{k}_{IN}} + {\sum }_{g ∈ P} \vec{kg} + \vec{{k}_{F}} \vert \geq \vert \vec{{k}_{W}} \vert \qquad ( 1 )$$

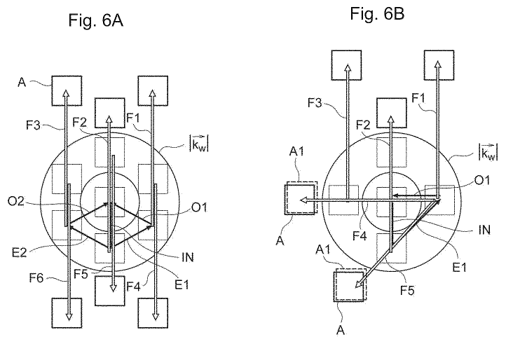

Σk_{g} in formula (1) also includes multiple diffractions with the same grating vector and includes a combination of grating vectors assumed to be an optical path. If formula (1) can be satisfied, the terminal point of the combined vectors is present in the evanescent region. This will be described with reference to FIG. 6. FIG. 6 shows wave number space coordinates indicating a design example of the grating vectors according to the embodiment of the present technique. As shown in FIG. 6, grating vectors IN, E1, E2, O1, O2, and F1 to F6 and field angle areas A are indicated.

The grating vector IN indicates a grating vector provided for the incidence diffraction grating 2. Among the grating vectors provided for the emission diffraction grating 4, the grating vectors E1 and E2 indicate grating vectors for externally (in front view, a direction orthogonal to the axis of light incident from the incidence diffraction grating into the light guide plate) expanding light in the front view of the light guide plate 1. The grating vectors O1 and O2 indicate basic grating vectors that emit light into the pupils of an observer, among the grating vectors provided for the emission diffraction grating 4. The grating vectors F1 to F6 are grating vectors provided for the function part 6. The grating vectors E1 and E2 and the basic grating vectors O1 and O2 are present on the front and back sides of the substrate 3.

As shown in FIGS. 6A and 6B, the terminal point of a vector is preferably present in the evanescent region, the vector serving as the sum of the wave vector of light incident into the light guide plate 1, the grating vector provided for the emission diffraction grating 4, the grating vector provided for the function part 6, and all combinations of grating vectors provided for any other diffraction gratings.

Light incident from the image forming unit can have various wavelengths. For light incident into the light guide plate and guided therein with all wavelengths and angles, the function part 6 is preferably designed such that the incidence diffraction grating 2, the function part 6, and the terminal point of a vector are present in the evanescent region, the vector serving as a combination of all the grating vectors provided for the diffraction gratings serving as a combination of the optical paths.

The field angle area A configured with the terminal point of the combined vectors is present in the evanescent region, thereby reducing the occurrence of ghosts and multiple images or the like. This can suppress deterioration of image quality.

If the foregoing formula (1) can be satisfied, the magnitude of the grating vector provided for the function part 6 may be different from substantially an integer multiple of the grating vector provided for the incidence diffraction grating 2 or the emission diffraction grating 4. This can be implemented by reducing the pitch of the diffraction grating provided for the function part 6.

For example, at a light source having a wavelength distribution from 500 nm to 560 nm, 500 nm on the short wavelength side particularly needs to be examined. If the refractive index of the substrate 3 is 2.0 and an image has a field angle range of 50°×50°, the pitch of the diffraction grating provided for the function part 6 can be about 100 nm.

The magnitude of the grating vector provided for the function part 6 is equal to substantially an integer multiple of the grating vector provided for the incidence diffraction grating 2 or the emission diffraction grating 4, the integer multiple being set at 2 or more, so that in any of the field angle areas, light incident on the function part 6 does not reach another field angle area in the light guide plate 1. This can suppress image quality deterioration caused by the occurrence of ghosts and improve light use efficiency.

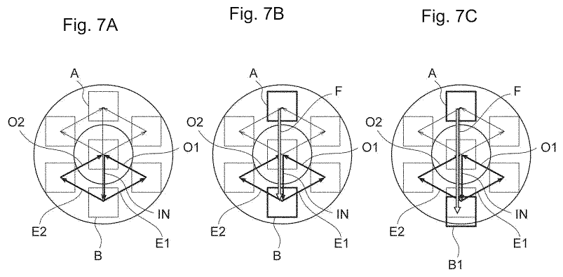

Referring to FIG. 7, a design example of the light guide plate 1 will be described below, in which the magnitude of the grating vector F is not equal to substantially an integer multiple of the magnitude of the grating vector IN, the integer multiple being set at 2 or more. FIG. 7 shows wave number space coordinates indicating a design example of the grating vectors according to the embodiment of the present technique. As shown in FIG. 7, grating vectors IN, E1, E2, O1, O2, and F and field angle areas A and B are indicated.

The grating vector IN indicates a grating vector provided for the incidence diffraction grating 2. Among the grating vectors provided for the emission diffraction grating 4, the grating vectors E1 and E2 indicate grating vectors for externally (in front view, a direction orthogonal to the axis of light incident from the incidence diffraction grating into the light guide plate) expanding light in the front view of the light guide plate 1. The grating vectors O1 and O2 indicate basic grating vectors that emit light into the pupils of an observer, among the grating vectors provided for the emission diffraction grating 4. The grating vector F is a grating vector provided for the function part 6. The grating vectors E1 and E2 and the basic grating vectors O1 and O2 are present on the front and back sides of the substrate 3.

As illustrated in FIG. 7A, the field angle areas A that can be present in the light guide plate 1 are indicated by the grating vectors IN, E1, E2, O1, and O2.

In this design example of FIG. 7B, the magnitude of the grating vector F is equal to substantially an integer multiple of the magnitude of the grating vector IN, the integer multiple being set at 2 or more. Thus, even the field angle area A diffracted by the grating vector F coincides with the field angle area B.

In contrast, in the design example of FIG. 7C, the magnitude of the grating vector F is not equal to substantially an integer multiple of the magnitude of the grating vector IN, the integer multiple being set at 2 or more. Thus, if the field angle area A is diffracted by the grating vector F, the field angle area A is shifted to a field angle area B1 without coinciding with the field angle area B. This may cause a ghost like multiple images and deteriorate image quality because the sum of the vectors is not 0.

### [(4) Transmittance and Reflectance of Function Part]

In order to suppress a loss caused by Fresnel reflection, the function part 6 preferably has zeroth-order transmitted light with a high transmittance, the transmitted light being incident from the image forming unit into the light guide plate 1. In particular, when the substrate 3 has a refractive index of n_{b}, a transmittance T0 of zeroth-order transmitted light of the function part 6 substantially at the center of the field angle area for guiding light preferably satisfies formula (2) below.

$$T 0 > 1 - {( {n}_{b} - 1 )}^{2} / {( {n}_{b} + 1 )}^{2} \qquad ( 2 )$$

Specifically when the substrate 3 has a refractive index of, for example, about 2.0 or more, zeroth-order transmitted light preferably has a transmittance of 90% or more. When the substrate 3 has a refractive index of about 1.5 or more, zeroth-order transmitted light preferably has a transmittance of 98% or more. A preferable threshold value varies depending upon the refractive index of the substrate 3.

Furthermore, in the function part 6, a high reflectance is preferably set for zeroth-order reflected light incident at an angle of light guided from the inside of the light guide plate 1. In particular, when a ratio S1 is obtained between a cross-sectional area of a pencil of light in parallel with the incidence diffraction grating 2 and a cross-sectional area of the pencil of light impinging on the function part 6, the pencil of light being diffracted into the light guide plate 1 by the incidence diffraction grating 2, the zeroth-order reflected light of the function part 6 preferably has a reflectance R0 that satisfies formula (3) below.

$$T 0 \times ( 1 - S 1 ) + T 0 \times S 1 \times R 0 > 1 - ( {n}_{b} - {1}^{2} / {( {n}_{b} + 1 )}^{2} \qquad ( 3 )$$

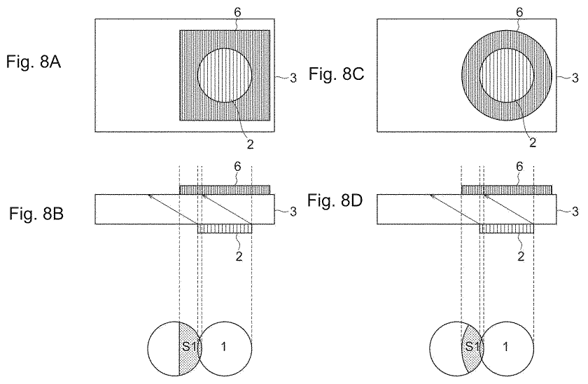

The ratio S1 is shown in FIG. 8. FIG. 8 is an explanatory drawing illustrating the ratio S1 according to the embodiment of the present technique. FIG. 8A is a schematic front view illustrating a configuration example of the light guide plate 1 according to the embodiment of the present technique. FIG. 8B is a schematic side view illustrating the configuration example of the light guide plate 1 in FIG. 8A. FIG. 8C is a schematic front view illustrating a different configuration example of the light guide plate 1 from FIG. 8A. FIG. 8D is a schematic side view illustrating the configuration example of the light guide plate 1 in FIG. 8C. As shown in FIGS. 8B and 8D, the ratio S1 is defined between a cross-sectional area of a pencil of light in parallel with the incidence diffraction grating 2 and a cross-sectional area of the pencil of light impinging on the function part 6, the pencil of light being diffracted into the light guide plate 1 by the incidence diffraction grating 2.

Specifically the reflectance R0 of zeroth-order reflected light at the angle of guided light is determined by the transmittance T0 of zeroth-order transmitted light and an area of a pencil of guided light impinging on the function part 6 with respect to a cross section on a plane parallel to the surface of the substrate 3.

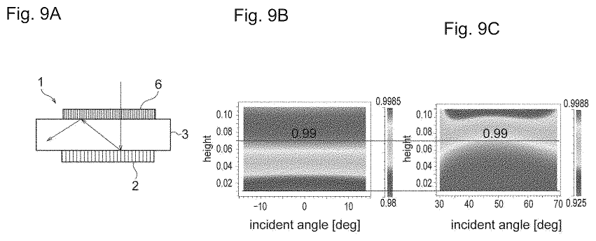

This will be described with reference to FIG. 9. FIG. 9A is a schematic side view illustrating a configuration example of the light guide plate 1 according to the embodiment of the present technique. As illustrated in FIG. 9A, the function part 6 transmits light incident into the light guide plate 1 from the image forming unit (not illustrated). At this point, zeroth-order transmitted light preferably has a high transmittance. Furthermore, the function part 6 may cause light diffracted at an angle of guided light by the incidence diffraction grating 2 to impinge on the function part 6 again in the process of guiding light. The zeroth-order reflected light preferably has a high reflectance. The high transmittance and the high reflectance can suppress a loss.

FIG. 9B is a graph indicating a design example of a transmittance of a function part 6 according to the embodiment of the present technique. In the graph on the left side of FIG. 9B, the horizontal axis indicates an incident angle of light from the image forming unit to the function part 6 and the vertical axis indicates a height of the diffraction grating provided for the function part 6. Calibration markings on the right side of FIG. 9B indicate the reference values of a transmittance. Correspondences are established between the depth of a color in the graph on the left side of FIG. 9B and the depth of a color at the calibration markings on the right side of FIG. 9B. In FIG. 9B, zeroth-order transmitted light has a high transmittance of at least 98% as a whole regardless of the incident angle of light and the height of the diffraction grating.

FIG. 9C is a graph indicating a design example of a reflectance of the function part 6 according to the embodiment of the present technique. In the graph on the left side of FIG. 9C, the horizontal axis indicates an incident angle of light from the incidence diffraction grating 2 to the function part 6 and the vertical axis indicates a height of the diffraction grating provided for the function part 6. Calibration markings on the right side of FIG. 9C indicate the reference values of a reflectance. Correspondences are established between the depth of a color in the graph on the left side of FIG. 9C and the depth of a color at the calibration markings on the right side of FIG. 9C. FIG. 9C indicates the reflectance of zeroth-order reflected light when guided light impinges on the function part 6 if the height of the diffraction grating is changed relative to the incident angle of light. It is understood that the value can be changed from 92% to about 100% according to the design of the height of the diffraction grating.

As shown in FIGS. 9B and 9C, when the diffraction grating has a height of substantially 50 nm to substantially 90 nm in this design example, zeroth-order transmitted light has a high transmittance and zeroth-order reflected light of guided light has a high reflectance. A horizontal line in each of FIGS. 9B and 9C shows that the transmittance and the reflectance are 99%. Thus, when the area of light guided to impinge on the function part 6 again is 30% of the area of a pencil of light, the loss is 1−0.99×(1−0.3)+0.99×0.3×0.99×100≈1.3% in this design example as expressed in the foregoing formula (3).

Moreover, the substrate 3 has a refractive index of 2.0 and the function part 6 has a refractive index of 1.7. The design value varies depending upon, for example, the wavelength of light or the refractive indexes of the substrate 3 and the function part 6.

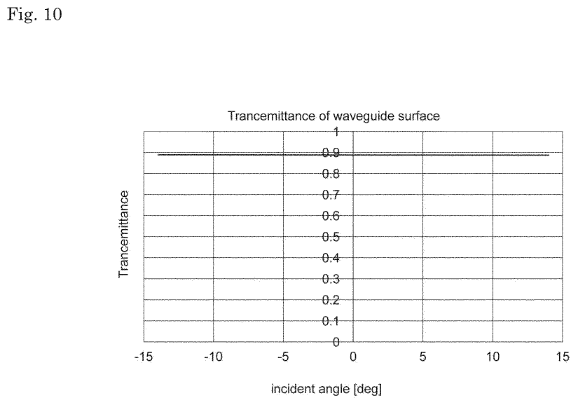

Referring to FIG. 10, an example of a transmittance on the surface of a conventional light guide plate will be described below without using the function part 6 according to the present technique. FIG. 10 is a graph showing an example of a transmittance on the surface of a light guide plate according to a comparative example of the embodiment of the present technique. In FIG. 10, the horizontal axis indicates an incident angle of light to the light guide plate, and the vertical axis indicates a transmittance. As shown in FIG. 10, the transmittance is 89%. Thus, the loss is 100−89=11%.

As described above, it was confirmed that the loss can be suppressed from 11% to 1%.

Means for increasing the transmittance and the reflectance is not particularly limited. For example, the function part 6 may be coated with a resin or metal having a predetermined refractive index. Furthermore, the height of the diffraction grating provided for the function part 6 may be adjusted. Alternatively the thickness of a residual film may be adjusted between the diffraction grating provided for the function part 6 and the substrate 3.

In the foregoing configuration example, the function part 6 has the grating vectors in one direction. The function part 6 may have grating vectors in multiple directions. In other words, the function part 6 may have two-dimensional diffraction gratings.

The contents described about the light guide plate according to the first embodiment of the present technique can be applied to other embodiments of the present technique unless any technical contradictions arise.

### 2. Second Embodiment (Example 2 of Light Guide Plate)

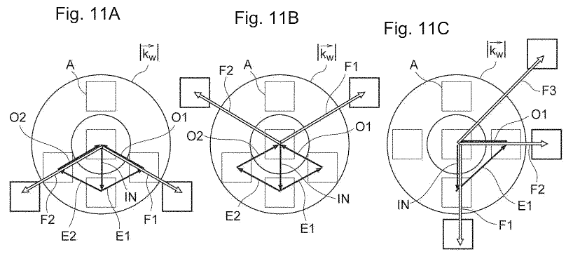

A function part 6 can include various grating vectors as long as the foregoing formula (1) can be satisfied. Referring to FIG. 11, another design example of diffraction gratings provided for the function part 6 will be described below. FIG. 11 shows wave number space coordinates indicating a design example of the grating vectors according to the embodiment of the present technique. As shown in FIG. 11, grating vectors IN, E1, E2, O1, O2, F1, F2, F3, and field angle areas A are indicated.

The grating vector IN indicates a grating vector provided for an incidence diffraction grating 2. Among the grating vectors provided for an emission diffraction grating 4, the grating vectors E1 and E2 indicate grating vectors for externally (in front view, a direction orthogonal to the axis of light incident from the incidence diffraction grating into a light guide plate) expanding light in the front view of a light guide plate 1. The grating vectors O1 and O2 indicate basic grating vectors that emit light into the pupils of an observer, among the grating vectors provided for the emission diffraction grating 4. The grating vectors F1, F2, and F3 are grating vectors provided for the function part 6. The grating vectors E1 and E2 and the basic grating vectors O1 and O2 are present on the front and back sides of the substrate 3.

As shown in FIG. 11A, the magnitude of the grating vector F1 may be substantially two times larger than the magnitude of the basic grating vector O1. The direction of the grating vector F1 may be substantially opposite to the direction of the basic grating vector O1. Likewise, the magnitude of the grating vector F2 may be substantially two times larger than the magnitude of the basic grating vector O2. The direction of the grating vector F2 may be substantially opposite to the direction of the basic grating vector O2.

As shown in FIG. 11B, the magnitude of the grating vector F1 may be substantially two times larger than the magnitude of the grating vector E1. The direction of the grating vector F1 may be substantially identical to the direction of the grating vector E1. Likewise, the magnitude of the grating vector F2 may be substantially two times larger than the magnitude of the grating vector E2. The direction of the grating vector F2 may be substantially identical to the direction of the grating vector E2.

As shown in FIG. 11C, the magnitude of the grating vector F1 may be substantially two times larger than the magnitude of the grating vector IN. The direction of the grating vector F1 may be substantially identical to the direction of the grating vector IN. Likewise, the magnitude of the grating vector F2 may be substantially two times larger than the magnitude of the grating vector O1. The direction of the grating vector F2 may be substantially opposite to the direction of the grating vector O1. Likewise, the magnitude of the grating vector F3 may be substantially two times larger than the magnitude of the grating vector E1. The direction of the grating vector F3 may be substantially identical to the direction of the grating vector E1. The shape of a polygon including the grating vector IN, the grating vector E1, and the grating vector O1 is not particularly limited.

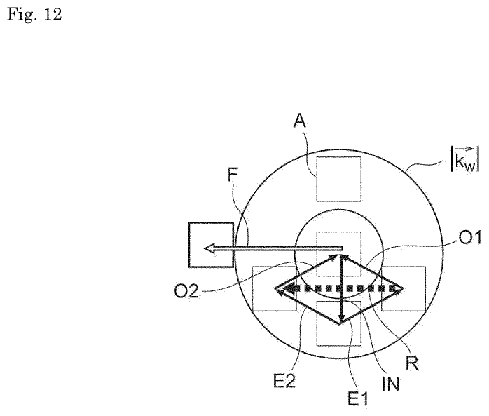

Referring to FIG. 12, another design example of diffraction gratings provided for the function part 6 will be described below. FIG. 12 shows wave number space coordinates indicating a design example of the grating vectors according to the embodiment of the present technique. As shown in FIG. 12, grating vectors IN, E1, E2, R, O1, O2, and F1 to F3, and field angle areas A are indicated.

The grating vector IN indicates a grating vector provided for the incidence diffraction grating 2. Among the grating vectors provided for the emission diffraction grating 4, the grating vectors E1 and E2 indicate grating vectors for externally (in front view, a direction orthogonal to the axis of light incident from the incidence diffraction grating into a light guide plate) expanding light in the front view of the light guide plate 1. The grating vector R indicates a grating vector having the function of returning light and connecting the vertexes of a polygon including the grating vectors that sum up to 0, among the grating vectors provided for the emission diffraction grating 4. The grating vectors O1 and O2 indicate basic grating vectors that emit light into the pupils of an observer, among the grating vectors provided for the emission diffraction grating 4. The grating vectors F1, F2, and F3 may be some of the grating vectors provided for the function part 6 or a combination thereof. The grating vectors E1 and E2 and the basic grating vectors O1 and O2 may be present on the front and back sides of a substrate 3.

In this design example, the grating vectors IN, E1, and O1 constitute a substantially isosceles triangle. Likewise, the grating vectors IN, E2, and O2 constitute a substantially isosceles triangle. The grating vector IN, the grating vector E1, and the basic grating vector O1 sum up to 0 and are closed. Likewise, the sum of the grating vector IN, the grating vector E2, and the basic grating vector O2 is 0. The grating vector R is a vector connecting the remotest vertexes of the two substantially isosceles triangles.

At this point, the magnitude of the grating vector F may be substantially identical to the magnitude of the grating vector R. The direction of the grating vector F may be substantially identical to the direction of the grating vector R. The direction of the grating vector F may be substantially opposite to the direction of the grating vector R.

The contents described about the light guide plate according to the second embodiment of the present technique can be applied to other embodiments of the present technique unless any technical contradictions arise.

### 3. Third Embodiment (Example 3 of Light Guide Plate)

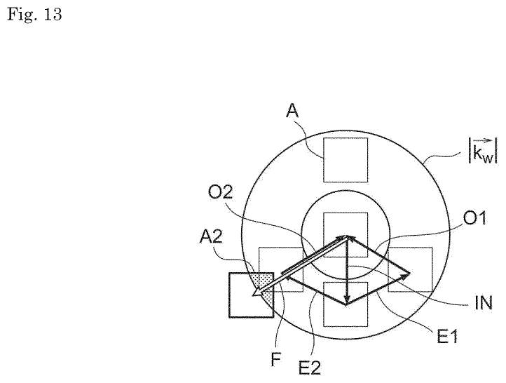

As described above, an overall field angle area is preferably present in an evanescent region, the field angle area being formed by a vector as a combination of a wave vector of light incident into a light guide plate 1, a grating vector provided for an incidence diffraction grating 2, a grating vector provided for an emission diffraction grating 4, and a grating vector provided for a function part 6. However, even if the size of a diffraction grating provided for the function part 6 is substantially equal to an integer multiple of the size of any one of the diffraction gratings, the field angle area may be partially absent in the evanescent region as long as diffraction efficiency can be 5% or less with respect to the field angle area expressed by formula (3) without parallelism with the diffraction grating. This will be described with reference to FIG. 13. FIG. 13 shows wave number space coordinates indicating a design example of the grating vectors according to an embodiment of the present technique. As shown in FIG. 13, grating vectors IN, E1, E2, O1, O2, and F and field angle areas Aare indicated.

The grating vector IN indicates the grating vector provided for the incidence diffraction grating 2. Among the grating vectors provided for the emission diffraction grating 4, the grating vectors E1 and E2 indicate grating vectors for externally (in front view, a direction orthogonal to the axis of light incident from the incidence diffraction grating into a light guide plate) expanding light in the front view of the light guide plate 1. The grating vectors O1 and O2 indicate basic grating vectors that emit light into the pupils of an observer, among the grating vectors provided for the emission diffraction grating 4. The grating vector F is a grating vector provided for the function part 6. The grating vectors E1 and E2 and the basic grating vectors O1 and O2 are present on the front and back sides of a substrate 3.

In this design example, the magnitude of the grating vector F is not substantially two times larger than that of the basic grating vector O2. Furthermore, a field angle area A2 as a part of the field angle area A is not present in the evanescent region. However, if diffraction efficiency for the field angle area A2 is suppressed to 5% or less, the grating vector can be used in a color such as blue with a low ghost ratio and particularly low luminosity. In other words, To the extent that the following formula (4) is satisfied, when the grating vector provided for the function part 6 has diffraction efficiency of 5% or less, ghosts can be avoided while suppressing a loss caused by Fresnel reflection. In this example, the direction is set with, in particular, a large pitch, thereby reducing the degree of difficulty in manufacturing.

$$[ Math . 2 ]$$

$$\vert \vec{{k}_{λ}} + \vec{{k}_{IN}} + {\sum }_{g ∈ P} \vec{kg} + \vec{{k}_{F}} \vert < \vert \vec{{k}_{W}} \vert \qquad ( 4 )$$

If a plurality of light guide plates 1 are stacked or a plurality of optical wavelengths are present, light incident into the function part 6 is preferably examined with all wavelengths and angles.

The contents described about the light guide plate according to the third embodiment of the present technique can be applied to other embodiments of the present technique unless any technical contradictions arise.

### 4. Fourth Embodiment (Example 4 of Light Guide Plate)

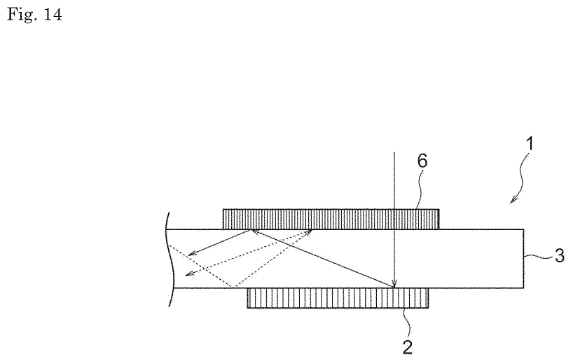

Light incident into a substrate 3 through a function part 6 may be guided in the substrate 3 and then may be incident into the function part 6 again. At this point, the function part 6 preferably returns the light by reflecting the light in a direction opposite to the incident direction. This will be described with reference to FIG. 14. FIG. 14 is a schematic side view illustrating a configuration example of a light guide plate 1 according to an embodiment of the present technique.

As illustrated in FIG. 14, the function part 6 transmits light incident from an image forming unit (not illustrated) into the light guide plate 1. This light is indicated by solid lines. This light is reflected by an incidence diffraction grating 2 and then is reflected by the function part 6. Thereafter, this light is guided while being totally reflected in the substrate 3. The guided light may be incident into the function part 6 again. This light is indicated by broken lines. At this point, the function part 6 preferably reflects and returns the light in a direction (the left direction in FIG. 14) opposite to the incident direction. This increases light use improvement.

In order to attain the effect, in side view, the cross-sectional shape of a diffraction grating provided for the function part 6 is preferably asymmetrical with respect to a direction (the horizontal direction in FIG. 14) orthogonal to a direction (the vertical direction in FIG. 14) along which light is incident at an incident angle of 0°. In FIG. 14, if incident light traveling to the left impinges on the function part 6, the reflectance of zeroth-order reflected light needs to be increased. For returned light that is guided from the left to the right, the function part 6 is preferably allowed to have efficiency of minus primary reflection diffraction to the left. Thus, the function part 6 can reflect light incident from the right in FIG. 14 to the left and can reflect light incident from the left in FIG. 14 to the left.

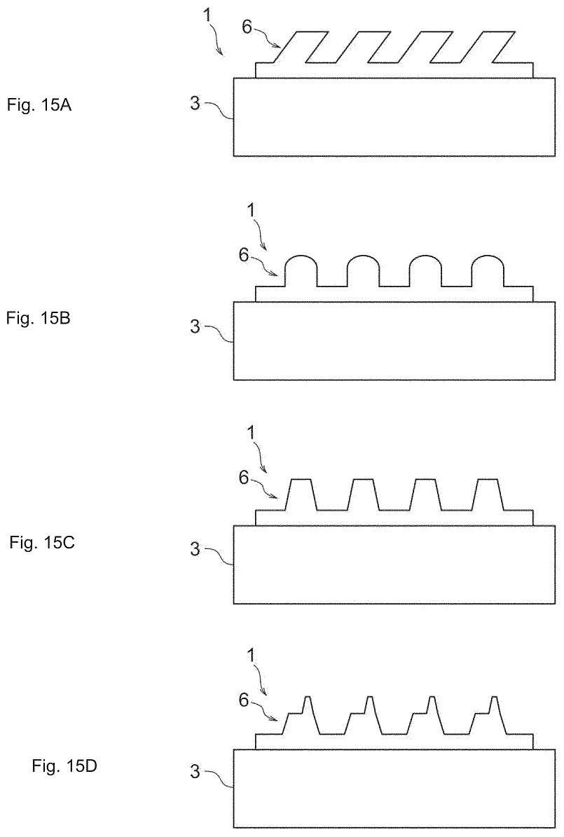

Referring to FIG. 15, a configuration example of diffraction gratings provided for the function part 6 will be described below. FIG. 15 is a schematic cross-sectional view illustrating the configuration example of the diffraction gratings provided for the function part 6 according to the embodiment of the present technique. The cross-sectional shape of the diffraction grating is not limited to this example.

As illustrated in FIGS. 15A and 15D, the cross-sectional shape of the diffraction grating provided for the function part 6 is asymmetrical with respect to a direction (the horizontal direction in FIGS. 15A and 15D) orthogonal to a direction (the vertical direction in FIGS. 15A and 15D) along which light is incident at an incident angle of 0°. As illustrated in FIGS. 15B and 15C, the cross-sectional shape of the diffraction grating may be symmetrical with respect to a direction (the horizontal direction in FIGS. 15B and 15C) orthogonal to a light incident direction (the vertical direction in FIGS. 15B and 15C).

As illustrated in FIG. 15A, the diffraction grating may be an overhanging trapezoid in cross section. As illustrated in FIG. 15B, the diffraction grating may be dome-like in cross section. As illustrated in FIG. 15C, the diffraction grating may be trapezoidal in cross section. As illustrated in FIG. 15D, the diffraction grating may be formed in the height direction in, for example, a binary pattern, a trapezoidal pattern, or a stepped pattern in cross section. This is also applicable to a two-dimensional lattice as well as a one-dimensional lattice.

The contents described about the light guide plate according to the fourth embodiment of the present technique can be applied to other embodiments of the present technique unless any technical contradictions arise.

### 5. Fifth Embodiment (Example 5 of Light Guide Plate)

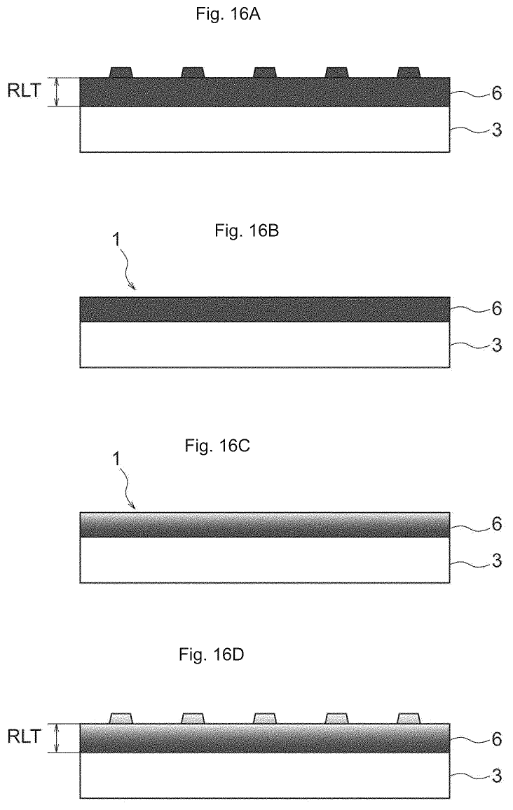

Among the faces of a function part 6, the entry face of light or the emission surface of the light or both of the faces may be substantially flat faces with diffraction gratings at a height of 20 nm or less. This will be described with reference to FIG. 16. FIG. 16 is a schematic side view illustrating a configuration example of a light guide plate 1 according to an embodiment of the present technique.

In the configuration example of FIG. 16A, among the faces of the function part 6, the entry face of light or the emission surface of the light or both of the faces may be substantially flat faces with diffraction gratings at a height of 20 nm or less. It is preferable that the refractive index of the function part 6 is lower than the refractive index of a substrate 3. Specifically it is preferable that the refractive index of the function part 6 is lower than the refractive index of the substrate 3 by 0.1 or more. Furthermore, the thickness of a residual film between the diffraction grating provided for the function part 6 and the substrate is preferably 20 nm or more. More preferably the thickness of the residual film is 40 nm or more. Thus, the function part 6 can suppress a loss caused by Fresnel reflection.

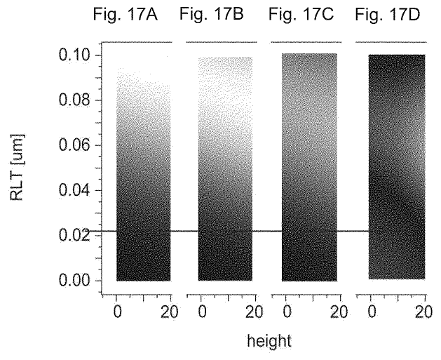

This will be described with reference to FIG. 17. FIG. 17 is a graph showing simulation results of the function part 6 according to the embodiment of the present technique.

FIG. 17A is a graph when the function part 6 has a refractive index of 1.3 while the substrate 3 has a refractive index of 2.0. FIG. 17B is a graph when the function part 6 has a refractive index of 1.5. FIG. 17C is a graph when the function part 6 has a refractive index of 1.7. FIG. 17D is a graph when the function part 6 has a refractive index of 1.9.

In FIGS. 17A to 17D, the horizontal axis indicates a height (0 to 20 nm) of the diffraction grating provided for the function part 6, and the vertical axis indicates a thickness (0.00 to 0.10 μm) of the residual film, that is, a thickness of the function part 6. A depth of a color indicates a transmittance. The larger the thickness of the residual film, the higher the transmittance.

As shown in FIGS. 17A to 17D, when the refractive index of the function part 6 is lower than the refractive index of the substrate 3 by 0.1 or more and the function part 6 has a thickness of 20 nm or more, a high transmittance is obtained and a loss caused by Fresnel reflection can be suppressed. When the refractive index of the function part 6 is lower than the refractive index of the substrate 3 by 0.1 or more and the function part 6 has a thickness of 40 nm or more, a higher transmittance is obtained and a loss caused by Fresnel reflection can be further suppressed.

FIG. 16 is referred back for description. As illustrated in FIG. 16B, among the faces of the function part 6, the diffraction grating may be absent on the entry face of light. At this point, it is preferable that the refractive index of the function part 6 is lower than the refractive index of the substrate 3 by 0.1 or more. Furthermore, the thickness of the function part 6 is preferably 20 nm or more.

Also in the configuration example of FIG. 16C, the refractive index of the function part 6 is lower than the refractive index of the substrate 3 by 0.1 or more. The thickness of the function part 6 is preferably 20 nm or more. Furthermore, the refractive index of the function part 6 decreases as a distance from the substrate 3 increases in side view. In other words, the refractive index of the function part 6 increases toward the substrate 3. This suppresses a rapid change of the refractive index at the interface between the function part 6 and the substrate 3. Hence, the function part 6 can suppress a loss caused by Fresnel reflection. It is preferable that the refractive index of the function part 6 at the farthest position from the substrate 3 is lower than the refractive index of the substrate 3 by 0.1 or more. The refractive index is preferably minimized.

As illustrated in FIG. 16D, the function part 6 may have diffraction gratings. The entry face of light or the emission surface of the light or both of the faces may be substantially flat faces with diffraction gratings at a height of 20 nm or less. It is preferable that the refractive index of the diffraction grating is lower than the refractive index of the substrate 3 and decreases as a distance from the substrate 3 increases in side view. At this point, it is preferable that the refractive index of the function part 6 is lower than the refractive index of the substrate 3 by 0.1 or more. It is preferable that the refractive index of the function part 6 at the farthest position from the substrate 3 is lower than the refractive index of the substrate 3 by 0.1 or more. The refractive index is preferably minimized. Furthermore, the thickness of a residual film between the diffraction grating provided for the function part 6 and the substrate is preferably 20 nm or more. More preferably the thickness of the residual film is 40 nm or more. Thus, the function part 6 can suppress a loss caused by Fresnel reflection.

The contents described about the light guide plate according to the fifth embodiment of the present technique can be applied to other embodiments of the present technique unless any technical contradictions arise.

### 6. Sixth Embodiment (Example 6 of Light Guide Plate)

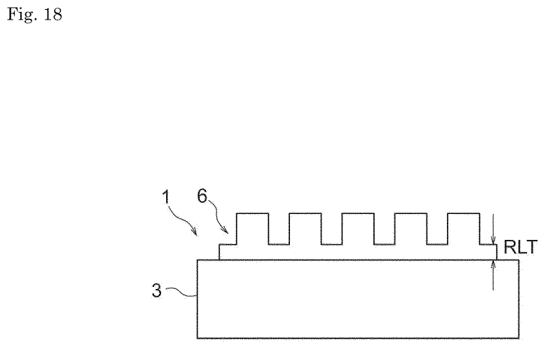

When a function part 6 includes diffraction gratings, it is preferable that the thickness of a residual film formed between the diffraction grating and a substrate 3 is preferably 20 nm or more and the refractive index of the function part 6 is lower than the refractive index of the substrate 3 by 0.2 or more. The thickness of the residual film will be described with reference to FIG. 18. FIG. 18 is a schematic side view illustrating a configuration example of a light guide plate 1 according to an embodiment of the present technique.

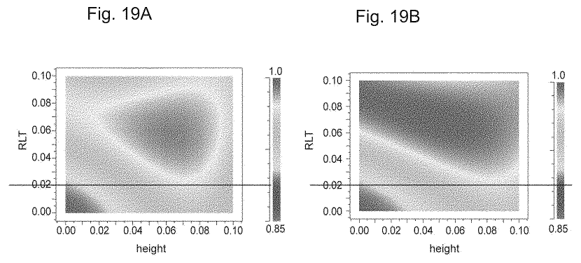

FIG. 18 shows a residual film thickness RLT that is the thickness of the residual film formed between the diffraction grating provided for the function part 6 and the substrate 3. When the residual film thickness RLT is 20 nm or more and the refractive index of the function part 6 is lower than the refractive index of the substrate 3 by 0.2 or more, the transmittance of light incident into the function part 6 from an image forming unit can be increased, thereby increasing the reflectance of light incident into the function part 6 from the inside of the light guide plate 1. Thus, a loss caused by Fresnel reflection can be suppressed. This will be described with reference to FIG. 19.

FIG. 19A is a graph indicating a design example of a transmittance of the function part 6 according to the embodiment of the present technique. FIG. 19A shows the design example when the refractive index of the function part 6 is lower than the refractive index of the substrate 3 by about 0.3. For simple examination of the transmittance of zeroth-order transmitted light and the reflectance of zeroth-order reflected light of guided light, a value is obtained by multiplying diffraction efficiency on a color bar. In the graph on the left side of FIG. 19A, the horizontal axis indicates a height of the diffraction grating provided for the function part 6 and the vertical axis indicates a residual film thickness RLT (μm). Calibration markings on the right side of FIG. 19A indicate the reference values of a transmittance. Correspondences are established between the depth of a color in the graph on the left side of FIG. 19A and the depth of a color at the calibration markings on the right side of FIG. 19A. FIG. 19A shows that a transmittance is high when the residual film thickness RLT is 20 nm or more.

FIG. 19B is a graph indicating a design example of a reflectance of the function part 6 according to the embodiment of the present technique. FIG. 19B shows the design example when the refractive index of the function part 6 is lower than the refractive index of the substrate 3 by about 0.5. In the graph on the left side of FIG. 19B, the horizontal axis indicates a height of the diffraction grating provided for the function part 6 and the vertical axis indicates a residual film thickness RLT (μm). Calibration markings on the right side of FIG. 19B indicate the reference values of a reflectance. Correspondences are established between the depth of a color in the graph on the left side of FIG. 19B and the depth of a color at the calibration markings on the right side of FIG. 19B. FIG. 19B shows that a reflectance is high when the residual film thickness RLT is 20 nm or more.

The refractive index of the function part 6 may be substantially equal to the refractive index of the substrate 3. At this point, the residual film thickness RLT is not particularly limited. Moreover, the refractive index of the function part 6 may be higher than the refractive index of the substrate 3. At this point, the residual film thickness RLT is preferably smaller than 20 nm. In short, it is preferable that the refractive index of the function part 6 is higher than the refractive index of the substrate 3 by 0.1 or more and the residual film thickness is smaller than 20 nm. The residual film thickness is a thickness of the residual film formed between the diffraction grating provided for the function part 6 and the substrate 3.

The contents described about the light guide plate according to the sixth embodiment of the present technique can be applied to other embodiments of the present technique unless any technical contradictions arise.

### 7. Seventh Embodiment (Example 7 of Light Guide Plate)

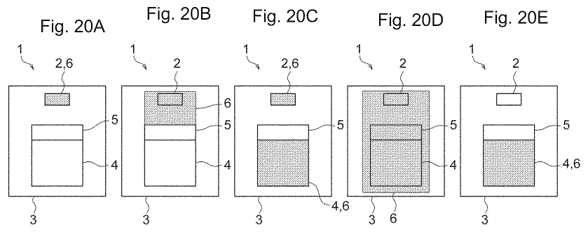

A function part 6 may be provided on an optical path where light to be incident into an incidence diffraction grating 2 travels straight ahead. Alternatively the function part 6 may be provided on an optical path where light to be emitted from an emission diffraction grating 4 travels straight ahead. Alternatively the function part 6 may be provided on the optical path where light to be incident into the incidence diffraction grating 2 travels straight ahead and the optical path where light to be emitted from the emission diffraction grating 4 travels straight ahead. This will be described with reference to FIG. 20. FIG. 20 is a schematic front view illustrating a configuration example of a light guide plate 1 according to an embodiment of the present technique.

As illustrated in FIGS. 20A to 20E, the light guide plate 1 includes the incidence diffraction grating 2, a substrate 3, the function part 6, the emission diffraction grating 4, and the expansion diffraction grating 5. The expansion diffraction grating 5 expands light guided by the substrate 3 by externally (in front view, a direction orthogonal to the axis of light incident from the incidence diffraction grating into a light guide plate) diffracting the light. The expansion diffraction grating 5 may be omitted. In other words, the light guide plate 1 includes one or both of the emission diffraction grating 4 that diffracts light guided by the substrate 3 and emits the light into the pupils of an observer and the expansion diffraction grating 5 that expands light by diffracting the light in a direction orthogonal to the axis of light in front view, the light being incident from the incidence diffraction grating 2 into the light guide plate 1.

In the configuration example of FIG. 20A, the function part 6 is provided on an optical path where light to be incident into the incidence diffraction grating 2 travels straight ahead. In other words, as illustrated in FIG. 2, the function part 6 is provided on a surface opposed to the incidence diffraction grating 2. Thus, the function part 6 can suppress a loss of light incident into the incidence diffraction grating 2, the loss being caused by Fresnel reflection.

In the configuration example of FIG. 20B, the function part 6 is provided on an optical path where light to be incident into the incidence diffraction grating 2 travels straight ahead. Moreover, an end of the function part 6 reaches the expansion diffraction grating 5. Thus, the area of the function part 6 may be larger than the area of the incidence diffraction grating 2. This facilitates manufacturing if the incidence diffraction grating 2 has a small size and thus causes a high degree of difficulty in manufacturing.

In the configuration example of FIG. 20C, the function part 6 is provided on the optical path where light to be incident into the incidence diffraction grating 2 travels straight ahead and the optical path where light to be emitted from the emission diffraction grating 4 travels straight ahead. In other words, the function part 6 is provided on a surface opposed to the incidence diffraction grating 2 and a surface opposed to the emission diffraction grating 4. This configuration example can be implemented when the emission diffraction grating 4 is disposed on one surface of the substrate 3. Thus, the function part 6 can suppress a loss of light incident into the incidence diffraction grating 2, the loss being caused by Fresnel reflection. Furthermore, the function part 6 can suppress a loss of light incident into the emission diffraction grating 4, the loss being caused by Fresnel reflection.

In the configuration example of FIG. 20D, the function part 6 is provided on a surface opposed to the incidence diffraction grating 2, the emission diffraction grating 4, and the expansion diffraction grating 5. The function part 6 is provided on the optical path where light to be incident into the incidence diffraction grating 2 travels straight ahead and the optical path where light to be emitted from the emission diffraction grating 4 travels straight ahead. Thus, the function part 6 can suppress a loss of light incident into the incidence diffraction grating 2, the loss being caused by Fresnel reflection. Furthermore, the function part 6 can suppress a loss of light incident into the emission diffraction grating 4, the loss being caused by Fresnel reflection. The function part 6 provided over the surface can suppress deterioration of a wave front at an edge and avoid design deterioration caused by visual identification of a pattern area.

In the configuration example of FIG. 20E, the function part 6 is provided on an optical path where light to be incident into the emission diffraction grating 4 travels straight ahead. In other words, the function part 6 is provided on a surface opposed to the emission diffraction grating 4. Thus, the function part 6 can suppress a loss of light incident into the emission diffraction grating 4, the loss being caused by Fresnel reflection. The area of the function part 6 may be larger than the area of the emission diffraction grating 4.

The position where the function part 6 is provided is not limited to the above-mentioned positions. In addition to a position where the diffraction grating is formed or a position where the diffraction grating is not formed, the function part 6 can be provided at any position in the light guide plate 1.

The contents described about the light guide plate according to the seventh embodiment of the present technique can be applied to other embodiments of the present technique unless any technical contradictions arise.

### 8. Eighth Embodiment (Example 8 of Light Guide Plate)

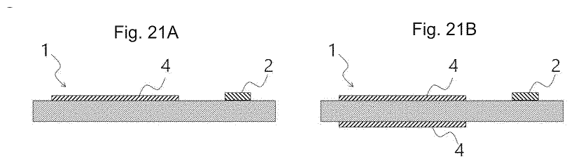

An emission diffraction grating 4 may be disposed on one or both surfaces of a light guide plate 1. This will be described with reference to FIG. 21. FIG. 21 is a schematic side cross-sectional view illustrating a configuration example of the light guide plate 1 according to an embodiment of the present technique.

As illustrated in FIG. 21A, the emission diffraction grating 4 may be disposed only on one surface of the light guide plate 1. Thus, the manufacturing process is simplified and the manufacturing cost is reduced.

As illustrated in FIG. 21B, the emission diffraction grating 4 may be disposed on both surfaces of the light guide plate 1. This further increases the degree of freedom in design. Consequently the light use efficiency can be increased and the brightness distribution can be improved. For example, the emission diffraction grating 4 disposed on one surface can control the direction that guides light in the light guide plate 1, and the emission diffraction grating 4 disposed on the other surface can emit light into the pupils of an observer.

The positions where the incidence diffraction grating 2 and the emission diffraction grating 4 are disposed are not limited thereto. The incidence diffraction grating 2 and the emission diffraction grating 4 may be disposed on the same surface or may be disposed on different surfaces. The positions of the diffraction gratings vary depending upon which one of a transmission grating and a reflection grating is used.

The contents described about the light guide plate according to the eighth embodiment of the present technique can be applied to other embodiments of the present technique unless any technical contradictions arise.

### 9. Ninth Embodiment (Example 9 of Light Guide Plate)

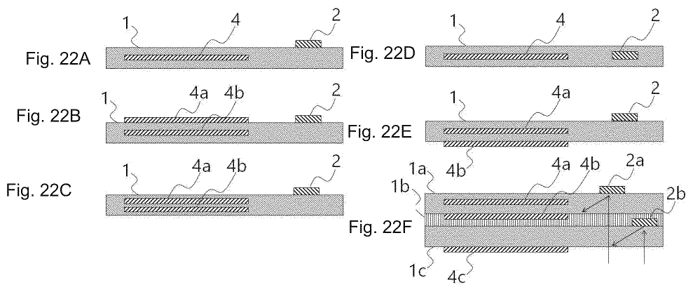

An emission diffraction grating 4 may be disposed at the same position or a different position with respect to an incidence diffraction grating 2 in the thickness direction of a light guide plate 1. The light guide plate 1 may include one or more incidence diffraction gratings 2 and one or more emission diffraction gratings 4. This will be described with reference to FIG. 22. FIG. 22 is a schematic side cross-sectional view illustrating a configuration example of the light guide plate 1 according to an embodiment of the present technique.

As shown in FIG. 22A, the emission diffraction grating 4 may be disposed on a different surface from the incidence diffraction grating 2. In this configuration example, the emission diffraction grating 4 is disposed in the light guide plate 1. At this point, a function part 6 may be disposed on one surface or both surfaces of the light guide plate 1.

As illustrated in FIGS. 22B, 22C, and 22E, the light guide plate 1 may include the single incidence diffraction grating 2 and a plurality of emission diffraction gratings 4a and 4b. In the configuration example illustrated in FIG. 22B, the incidence diffraction grating 2 and the emission diffraction grating 4a are disposed on the same surface and are disposed on a surface of the light guide plate 1. The emission diffraction grating 4b is disposed in the light guide plate 1. In the configuration example illustrated in FIG. 22C, the emission diffraction gratings 4a and 4b are disposed in the light guide plate 1. In the configuration example illustrated in FIG. 22E, the emission diffraction grating 4a is disposed in the light guide plate 1 and the emission diffraction grating 4b is disposed on a surface of the light guide plate 1.

In the configuration example illustrated in FIG. 22D, the incidence diffraction grating 2 and the emission diffraction grating 4 are disposed in the light guide plate 1. The incidence diffraction grating 2 and the emission diffraction grating 4 may be located at the same position or different positions in the thickness direction of the light guide plate 1.

As illustrated in FIG. 22F, the light guide plate 1 may include a plurality of incidence diffraction gratings 2a and 2b and a plurality of emission diffraction gratings 4a, 4b, and 4c. Alternatively a plurality of light guide plates 1 may be provided. In this configuration example, the incidence diffraction grating 2a is disposed on a surface of the light guide plate 1a and the emission diffraction grating 4a is disposed in the light guide plate 1a. The emission diffraction grating 4b and the incidence diffraction grating 2b are disposed in the light guide plate 1b. The emission diffraction grating 4c is disposed on a surface of the light guide plate 1c. The light guide plates 1a, 1b, and 1c are disposed and stacked in this order. For example, the light guide plates 1a and 1c can contain a material having a high refractive index and the light guide plate 1b can contain a material having a low refractive index. According to this configuration example, the light guide plate 1 can emit a plurality of light beams having different wavelengths to the pupils of an observer. Consequently coloring and an increased field angle can be obtained. The incidence diffraction gratings 2a and 2b may be located at the same position or different positions in the longitudinal direction of the light guide plate 1. The incidence diffraction gratings 2a and 2b are located at different positions, so that a plurality of light beams having different wavelengths are incident at different positions. This can reduce the occurrence of crosstalk.

As described above, the emission diffraction grating 4 may be disposed on a surface of the light guide plate 1 or may be disposed at various positions in the thickness direction of the light guide plate 1.

The positions of the incidence diffraction gratings 2 and the emission diffraction gratings 4, the number of light guide plates 1, the number of incidence diffraction gratings 2, and the number of emission diffraction gratings 4 are disposed are not limited to those of the foregoing configuration examples. The foregoing configuration examples may be combined.

The contents described about the light guide plate according to the ninth embodiment of the present technique can be applied to other embodiments of the present technique unless any technical contradictions arise.

### 10. Tenth Embodiment (Example of Image Display Device)

The present technique provides an image display device including the light guide plate according to the first to tenth embodiments and an image forming unit that emits image light onto the light guide plate. This will be described with reference to FIG. 2. As illustrated in FIG. 2, the image display device 10 according to the embodiment of the present technique includes the light guide plate 1 and an image forming unit 9 that emits image light onto the light guide plate 1.

The image forming unit 9 forms image light. The image forming unit 9 allows use of a micro panel in order to produce video in the image forming unit 9. The micro panel may be, for example, a spontaneous light-emitting panel such as a micro LED or a micro OLED. An LED (Light Emitting Diode) light source or an LD (Laser Diode) light source or the like may be used in combination with an illumination optical system by using a reflection or a transmission liquid crystal.

Image light emitted at each angle from the image forming unit 9 is transformed into substantially parallel rays through, for example, a projector lens (not illustrated), is condensed by the incidence diffraction grating 2, and is incident into the light guide plate 1.

The image display device 10 may be a head-mounted display (HMD) that is mounted on the head of a user. Alternatively the image display device 10 may be disposed as an infrastructure at a predetermined site.

The contents described about the image display device according to the tenth embodiment of the present technique can be applied to other embodiments of the present technique unless any technical contradictions arise.

Note that the embodiments of the present technique are not limited to the foregoing embodiments and various modifications can be made without departing from the gist of the present technique.

The present technique can also be configured as follows:

[1]

A light guide plate including: an incidence diffraction grating that diffracts incident light into the light guide plate;
a substrate that internally and totally reflects the light diffracted into the light guide plate by the incidence diffraction grating and guides the light; and a function part that transmits or reflects the incident light or performs both of the transmission and the reflection,
wherein when the substrate has a refractive index of n_{b},
a transmittance T0 of zeroth-order transmitted light of the function part substantially at the center of the field angle area for guiding light satisfies formula (2) below:

$$T 0 > 1 - {( {n}_{b} - 1 )}^{2} / {( {n}_{b} + 1 )}^{2} \qquad ( 2 )$$

[2]

The light guide plate according to [1], wherein when a ratio S1 is defined between a cross-sectional area of a pencil of light in parallel with the incidence diffraction grating and a cross-sectional area of the pencil of light impinging on the function part, the pencil of light being diffracted into the light guide plate by the incidence diffraction grating,
a reflectance R0 of zeroth-order reflected light of the function part satisfies formula (3) below:

$$T 0 \times ( 1 - S 1 ) + T 0 \times S 1 \times R 0 > 1 - {( {n}_{b} - 1 )}^{2} / {( {n}_{b} + 1 )}^{2} \qquad ( 3 )$$

[3]

The light guide plate according to [1] or [2], further including one or both of an emission diffraction grating that diffracts the light guided by the substrate and emits the light into the pupils of an observer and an expansion diffraction grating that expands the light by diffracting the light in a direction orthogonal to the axis of light in front view, the light being incident from the incidence diffraction grating into the light guide plate.

[4]

The light guide plate according to [3], wherein the sum of a grating vector and a basic grating vector is 0, the grating vector being provided for the incidence diffraction grating, the basic grating vector being provided for the emission diffraction grating or the expansion diffraction grating or both of the diffraction gratings.

[5]

The light guide plate according to [3] or [4], wherein the emission diffraction grating includes a grating vector having the function of returning light and connecting the vertexes of a polygon including grating vectors that sum up to 0.

[6]

The light guide plate according to any one of [1] to [5], wherein the magnitude of a grating vector provided for the function part is equal to substantially an integer multiple of the magnitude of a grating vector provided for the incidence diffraction grating, the integer multiple being set at 2 or more, and the direction of the grating vector provided for the function part is substantially parallel to the grating vector provided for the incidence diffraction grating.

[7]

The light guide plate according to any one of [3] to [6], wherein the magnitude of a grating vector provided for the function part is equal to substantially an integer multiple of the magnitude of a grating vector provided for the emission diffraction grating, the integer multiple being set at 2 or more, and the direction of the grating vector provided for the function part is substantially parallel to the grating vector provided for the emission diffraction grating.

[8]

The light guide plate according to [6] or [7], wherein the magnitude of a grating vector provided for the function part is substantially equal to the magnitude of a grating vector having a function of returning the light, and the direction of the grating vector provided for the function part is substantially parallel to the grating vector having the function of returning the light.

[9]

The light guide plate according to any one of [3] to [8], wherein in wave number space coordinates,
when the wave vector of light incident into the light guide plate is k_{λ},
the grating vector provided for the incidence diffraction grating is k_{IN},
the grating vector provided for the incidence diffraction grating and any
diffraction grating except for the function part is k_{g},
the grating vector provided for the function part is k_{F},
the sum of the grating vectors determined by a light beam path P (P includes an empty set) except for the grating vectors provided for the incidence diffraction grating and the function part is Σ_{g∈P}k_{g}, and
a wave vector connecting an origin point and the boundary between the light guide region and the evanescent region of the light guide plate is k_{W}, formula (1) below is satisfied for all optical paths.

$$[ Math . 1 ]$$

$$\vert \vec{{k}_{λ}} + \vec{{k}_{IN}} + {\sum }_{g ∈ P} \vec{kg} + \vec{{k}_{F}} \vert \geq \vert \vec{{k}_{W}} \vert \qquad ( 1 )$$

The light guide plate according to any one of [1] to [9], wherein among the faces of the function part, the entry face of the light or the emission surface of the light or both of the faces are substantially flat faces with diffraction gratings at a height of 20 nm or less,
the refractive index of the function part is lower than the refractive index of the substrate by 0.1 or more, and
the thickness of a residual film formed between the diffraction grating provided for the function part and the substrate is 20 nm or more.
   [11]

The light guide plate according to [10], wherein the residual film thickness is 40 nm or more.

[12]

The light guide plate according to [10] or [11], wherein the refractive index of the function part decreases as a distance from the substrate increases in side view.

[13]

The light guide plate according to any one of [1] to [12], wherein the refractive index of the function part is higher than the refractive index of the substrate by 0.1 or more, and
the thickness of the residual film formed between the diffraction grating provided for the function part and the substrate is smaller than 20 nm.
   [14]

The light guide plate according to any one of [9] to [13], wherein the grating vector provided for the function part has diffraction efficiency of 5% or less to the extent that the following formula (4) is satisfied:

$$[ Math . 2 ]$$

$$\vert \vec{{k}_{λ}} + \vec{{k}_{IN}} + {\sum }_{g ∈ P} \vec{kg} + \vec{{k}_{F}} \vert < \vert \vec{{k}_{W}} \vert \qquad ( 4 )$$

The light guide plate according to any one of [1] to [14], wherein in side view, the cross-sectional shape of the diffraction grating provided for the function part is asymmetrical with respect to a direction orthogonal to a direction along which the light is incident at an incident angle of 0°.

[16]

The light guide plate according to any one of [1] to [15], wherein the function part is provided on an optical path where light to be incident into the incidence diffraction grating travels straight ahead.

[17]

The light guide plate according to any one of [3] to [16], wherein the function part is provided on an optical path where light to be emitted from the emission diffraction grating travels straight ahead.

[18]

The light guide plate according to any one of [3] to [17], wherein the function part is provided on the optical path where light to be incident into the incidence diffraction grating travels straight ahead and the optical path where light to be emitted from the emission diffraction grating travels straight ahead.

[19]

An image display device including: the light guide plate according to any one of [1] to [18]; and
an image forming unit that emits image light onto the light guide plate.

### REFERENCE SIGNS LIST

1 Light guide plate
2 Incidence diffraction grating
3 Substrate
4 Emission diffraction grating
5 Expansion diffraction grating
6 Function part
9 Image forming unit
10 Image display device
IN, E1, E2, O1, O2, F Grating vector

1. A light guide plate at least comprising: an incidence diffraction grating that diffracts incident light into the light guide plate;
a substrate that internally and totally reflects the light diffracted into the light guide plate by the incidence diffraction grating and guides the light; and
a function part that transmits or reflects the incident light or performs both of the transmission and the reflection,
wherein when the substrate has a refractive index of n_{b},
a transmittance T0 of zeroth-order transmitted light of the function part substantially at a center of a field angle area for guiding light satisfies formula (2) below:
$$T 0 > 1 - {( {n}_{b} - 1 )}^{2} / {( {n}_{b} + 1 )}^{2} \qquad ( 2 )$$

2. The light guide plate according to claim 1, wherein when a ratio S1 is defined between a cross-sectional area of a pencil of light in parallel with the incidence diffraction grating and a cross-sectional area of the pencil of light impinging on the function part, the pencil of light being diffracted into the light guide plate by the incidence diffraction grating,
a reflectance R0 of zeroth-order reflected light of the function part satisfies formula (3) below:
$$T 0 \times ( 1 - S 1 ) + T 0 \times S 1 \times R 0 > 1 - ( {n}_{b} - {1}^{2} / {( {n}_{b} + 1 )}^{2} \qquad ( 3 )$$

3. The light guide plate according to claim 1, further comprising one or both of an emission diffraction grating that diffracts the light guided by the substrate and emits the light into pupils of an observer and an expansion diffraction grating that expands the light by diffracting the light in a direction orthogonal to an axis of light in front view, the light being incident from the incidence diffraction grating into the light guide plate.

4. The light guide plate according to claim 3, wherein a sum of a grating vector and a basic grating vector is 0, the grating vector being provided for the incidence diffraction grating, the basic grating vector being provided for the emission diffraction grating or the expansion diffraction grating or both of the diffraction gratings.

5. The light guide plate according to claim 3, wherein the emission diffraction grating includes a grating vector having a function of returning light and connecting vertexes of a polygon including grating vectors that sum up to 0.

6. The light guide plate according to claim 1, wherein a magnitude of a grating vector provided for the function part is equal to substantially an integer multiple of a magnitude of a grating vector provided for the incidence diffraction grating, the integer multiple being set at 2 or more, and
a direction of the grating vector provided for the function part is substantially parallel to the grating vector provided for the incidence diffraction grating.

7. The light guide plate according to claim 3, wherein a magnitude of a grating vector provided for the function part is equal to substantially an integer multiple of a magnitude of a grating vector provided for the emission diffraction grating, the integer multiple being set at 2 or more, and
a direction of the grating vector provided for the function part is substantially parallel to the grating vector provided for the emission diffraction grating.

8. The light guide plate according to claim 6, wherein the magnitude of a grating vector provided for the function part is substantially equal to the magnitude of a grating vector having a function of returning the light, and
the direction of the grating vector provided for the function part is substantially parallel to the grating vector having the function of returning the light.

9. The light guide plate according to claim 3, wherein in wave number space coordinates,
when a wave vector of light incident into the light guide plate is k_{λ},
a grating vector provided for the incidence diffraction grating is k_{IN},
a grating vector provided for the incidence diffraction grating and any diffraction grating except for the function part is k_{g},
a grating vector provided for the function part is k_{F},
a sum of grating vectors determined by a light beam path P (P includes an empty set) except for the grating vectors provided for the incidence diffraction grating and the function part is Σ_{g∈P}k_{g}, and
a wave vector connecting an origin point and a boundary between a light guide region and an evanescent region of the light guide plate is k_{W}, formula (1) below is satisfied for all optical paths.
$$[ Math . 1 ]$$
$$\vert \vec{{k}_{λ}} + \vec{{k}_{IN}} + {\sum }_{g ∈ P} \vec{kg} + \vec{{k}_{F}} \vert \geq \vert \vec{{k}_{W}} \vert \qquad ( 1 )$$

10. The light guide plate according to claim 1, wherein among the faces of the function part, an entry face of the light or an emission surface of the light or both of the faces are substantially flat faces with diffraction gratings at a height of 20 nm or less,
a refractive index of the function part is lower than a refractive index of the substrate by 0.1 or more, and
a thickness of a residual film formed between the diffraction grating provided for the function part and the substrate is 20 nm or more.

11. The light guide plate according to claim 10, wherein the residual film thickness is 40 nm or more.

12. The light guide plate according to claim 10, wherein the refractive index of the function part decreases as a distance from the substrate increases in side view.

13. The light guide plate according to claim 1, wherein a refractive index of the function part is higher than a refractive index of the substrate by 0.1 or more, and
a thickness of a residual film formed between a diffraction grating provided for the function part and the substrate is smaller than 20 nm.

14. The light guide plate according to claim 9, wherein the grating vector provided for the function part has diffraction efficiency of 5% or less to the extent that the following formula (4) is satisfied:
$$[ Math . 2 ]$$
$$\vert \vec{{k}_{λ}} + \vec{{k}_{IN}} + {\sum }_{g ∈ P} \vec{kg} + \vec{{k}_{F}} \vert < \vert \vec{{k}_{W}} \vert \qquad ( 4 )$$

15. The light guide plate according to claim 1, wherein in side view, a cross-sectional shape of the diffraction grating provided for the function part is asymmetrical with respect to a direction orthogonal to a direction along which the light is incident at an incident angle of 0°.

16. The light guide plate according to claim 1, wherein the function part is provided on an optical path where the light to be incident into the incidence diffraction grating travels straight ahead.

17. The light guide plate according to claim 3, wherein the function part is provided on an optical path where the light to be emitted from the emission diffraction grating travels straight ahead.

18. The light guide plate according to claim 3, wherein the function part is provided on an optical path where the light to be incident into the incidence diffraction grating travels straight ahead and an optical path where the light to be emitted from the emission diffraction grating travels straight ahead.

19. An image display device comprising: the light guide plate according to claim 1; and
an image forming unit that emits image light onto the light guide plate.
